(19) United States
(12) Patent Application Publication
(10) Pub. No.: US 2025/0361402 A1
(43) Pub. Date: Nov. 27, 2025

(54) STABILISED CONCENTRATED MINERAL SUSPENSION

(71) Applicant: COATEX, Genay (FR)

(72) Inventors: Christian JACQUEMET, Lyon (FR); Laurie PARRENIN, Villeneuve (FR); Morgane LE NEINDRE, Curis-au-Mont-d’Or (FR)

(73) Assignee: COATEX, Genay (FR)

(21) Appl. No.: 18/873,912

(22) PCT Filed: Jun. 26, 2023
(86) PCT No.: PCT/FR2023/000124

§ 371 Date: Dec. 11, 2024

(30) Foreign Application Priority Data
Jul. 5, 2022 (FR) FR2206848

(51) Int. Cl. C09C 3/04; C08F 20/06; C08F 120/06; C09C 3/00; C09C 3/06; C09C 3/10

(52) U.S. Cl. CPC C09C 3/041; C08F 20/06; C08F 120/06; C09C 3/006; C09C 3/06; C09C 3/10

(57) ABSTRACT

An aqueous suspension of a mineral material, for example calcium carbonate, is described. The aqueous suspension is prepared by wet grinding step followed by a concentration step in the presence of at least one rheological agent R comprising phosphoric acid and an α-sulfonated polymer P which is completely or partially neutralised by a monovalent ion. A rheological agent R and the use of this mineral suspension for preparing a mass filler for paper, for preparing a paper coating slip, or for preparing a coating composition, for example a paint composition, is also described.

The invention provides an aqueous suspension of a mineral material, for example calcium carbonate, which is prepared by wet grinding and then concentration after grinding in the presence of at least one rheological agent R comprising phosphoric acid and an α-sulphonated polymer P that is totally or partially neutralised by means of a monovalent ion. The invention also relates to the rheological agent R as well as to the use of this mineral suspension for the preparation of a mass filler for papermaking or of a paper coating colour or even for the preparation of a coating composition, for example a paint composition.

There are known methods for preparing suspensions of mineral material. In particular, there are known methods that use additives in the various steps in these methods, in particular additives for controlling the rheology of the suspension when preparing it or when it is stored.

In general, the methods of grinding mineral material must be effective and make it possible to control the particle size distribution of the particles obtained. Furthermore, the mineral material grinding methods must have a high efficacy in terms of grinding time for a particular particle size distribution and for a defined amount of mineral material. In fact, when preparing a defined amount of mineral particles, reducing the operating time of the grinding equipment improves the overall yield of the method used to prepare an aqueous suspension of mineral material.

Likewise, it is important to have methods for grinding mineral material that make it possible to prepare aqueous suspensions of particles of mineral material that are stable not only shortly after preparation, but also several hours or days later. Viscosity drift phenomena must be controlled because they can lead to gelation of the prepared suspensions which would make handling difficult or impossible. Likewise, particle settling phenomena must be avoided or substantially slowed. In addition to controlling the stability, it is also essential to control the viscosity of the aqueous suspensions of particles of ground mineral material.

It is also important to be able to prepare aqueous suspensions of particles of mineral material with a high solids content. A high solids content of these aqueous suspensions of particles of mineral material makes it possible in particular to increase the productivity of the methods that use these suspensions and to limit the costs and resources required to convey these suspensions.

Furthermore, it should be possible to prepare rheology control agents in the absence of any compound that could be considered harmful from an environmental standpoint or in the absence of any compound that is restricted for use by regulatory provisions. In particular, preparing these agents in the absence of any compound comprising phosphorus should be preferred, especially the absence of any phosphorus in oxidation state I, III or V.

Furthermore, during papermaking, aqueous mineral filler compositions are used to provide a mineral filler within the pulp comprising water and fibres of vegetable origin, in particular fibres of cellulosic material. Within these compositions, the mineral filler is in the form of particles. The use of such mineral fillers makes it possible in particular to improve the physical properties of the paper, in particular to improve its optical properties, or to reduce the relative amount of cellulosic material in relation to the amount of mineral filler. Improving the efficacy of papermaking methods is also made possible through the use of these mineral fillers. The formation of flocs of mineral filler particles or of fibres that impair the quality of the paper must be limited. The ability to prepare suspensions of particles with a narrow size distribution must also be sought to improve the quality of coated paper using these suspensions. In particular, limiting the fraction of very fine particles then makes it possible to improve the opacity of the coated paper.

Improving the compatibility of the various compounds used in the preparation of paper should also be sought.

Document WO 02070571 describes the preparation of polyacrylic acid in ethanol in the presence of compounds comprising sulphur. These polymers are used to disperse ground calcium carbonate. Document FR 2846972 discloses an aqueous mineral suspension prepared in the presence of an acrylic polymer as a grinding aid agent. Document JP 2014105224 relates to a method of producing a suspension of mineral particles that uses an aqueous solution of poly(meth)acrylic acid polymer when grinding the mineral. Document WO 2014021345 describes a (meth)acrylic acid polymer prepared in the presence of a mercapto-carboxylic compound and suitable for use as a mineral particle dispersant. Document EP 2583984 describes the preparation of an aqueous mineral suspension in the presence of a partially neutralised phosphino-carboxylic polymer used as an agent for grinding mineral particles.

Thus, although there are methods for wet grinding mineral material, including some that can use polymers as grinding aid agents, the methods in the prior art do not always make it possible to provide a satisfactory solution to the problems encountered with the aqueous mineral suspensions obtained. There is therefore a need for improved aqueous suspensions of mineral material. The invention makes it possible to provide a solution to all or part of the problems of the suspensions in the prior art.

Thus, the invention provides an aqueous suspension S of particles of at least one mineral material M prepared:
by grinding in water an aqueous suspension Sd of at least one particulate mineral material M at a concentration ranging from 10% by weight to 60% by weight, then
by concentrating the ground suspension Sd to a concentration ranging from 65% by weight to 80% by weight, by a treatment chosen among mechanical treatment, heat treatment and combinations thereof, in the presence of at least one rheological agent R comprising phosphoric acid and at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised by means of at least one monovalent ion.

Preferably according to the invention, the suspension S has a Brookfield viscosity at 25° C., at 100 rpm, measured 1 hour after its preparation, of less than 1,000 mPa·s, preferably less than 800 mPa·s. Also preferably according to the invention, the suspension S has a Brookfield viscosity at 25° C., at 100 rpm and after stirring, measured 24 hours after preparation and storage at 60° C., of less than 800 mPa·s, preferably less than 600 mPa·s. Also preferably according to the invention, the suspension S has a Brookfield viscosity at 25° C., at 100 rpm and before stirring, measured 24 hours after preparation and storage at 60° C., of less than 3,000 mPa·s, preferably less than 2,500 mPa·s, more preferentially less than 2,000 mPa·s or less than 1,900 mPa·s.

Preferably, the suspension S uses a single material M or two or three materials M. According to the invention, the material M is synthetic or of natural origin. Preferably, the material M is chosen among alkaline-earth metal carbonate, more preferentially calcium carbonate (natural calcium carbonate or precipitated calcium carbonate), strontium carbonate, magnesium carbonate, barium carbonate and combinations thereof, dolomite, kaolin, titanium dioxide, talc, lime, calcium sulphate, barium sulphate and combinations thereof. Particularly preferably, the material M is chosen among natural calcium carbonate, precipitated calcium carbonate, magnesium carbonate, dolomite, kaolin, titanium dioxide, talc, lime. Much more preferably, the material Mis calcium carbonate.

Thus, essentially according to the invention, the aqueous suspension S and the suspension Sd comprise particles of at least one mineral material M. According to the invention, the concentration of the suspension S or of the suspension Sd is its concentration by weight in dry solids content of particles of material M. Preferably according to the invention, the concentration of the suspension S is greater than 70% by weight. Also preferably according to the invention, the concentration of the suspension S is less than 78% by weight or less than 75% by weight. More preferably according to the invention, the concentration of the suspension S ranges from 70% by weight to 78% by weight or from 70% by weight to 75% by weight.

According to the invention, the particles of ground material M have a median size, measured by sedimentation analysis, of less than 50 μm or a median size ranging from 0.05 to 50 μm or a median size of less than 10 μm, preferably less than 5 μm or less than 2 μm, more preferentially less than 1 μm or less than 0.5 μm.

Sedimentation analysis is a method of measuring the speed at which solid particles drop in a less dense liquid. Using Stokes' law, grain size is determined according to:
v: settling velocity (m/s)
g: acceleration due to gravity (m/s²)
Δγ: difference in density between the particles and the suspending liquid (kg/m³)
μ: viscosity of the suspending liquid (Pa·s).

The diameter of the particle or its Stokes diameter is then determined according to formula I:

$$d = √ ( \frac{18 μ v}{q Δγ} )$$

According to the invention, sedimentation analysis is carried out using X-rays that measure the absorption of radiation by the suspension at a given height and at a given time depending on the concentration.

Preferably according to the invention, the concentration of the suspension Sd is greater than 10% by weight. Also preferably according to the invention, the concentration of the suspension Sd is less than 60% by weight. More preferentially, the concentration of the suspension Sd ranges from 10% by weight to 60% by weight.

Essentially according to the invention, the ground suspension Sd is concentrated using a treatment chosen among mechanical treatment, heat treatment and combinations thereof, in the presence of a rheological agent R comprising phosphoric acid and at least one α-sulphonated polymer P.

Phosphoric acid is a compound of formula H₃PO₄. According to the invention, the concentration of the ground suspension Sd uses from 0.05% by weight to 3% by weight of phosphoric acid relative to the amount by weight of mineral material M. Preferably, phosphoric acid is used in an amount from 0.1% by weight to 3% by weight or from 0.1% by weight to 2% by weight of phosphoric acid relative to the amount by weight of mineral material M.

More preferably, phosphoric acid is used in an amount from 0.1% by weight to 1% by weight or from 0.1% by weight to 0.6% by weight of phosphoric acid relative to the amount by weight of mineral material M.

Preferably according to the invention, the rheological agent R comprises at least one polymer P chosen among an α-ω-disulphonated polymer P1, an α-monosulphonated polymer P2 and combinations thereof.

According to the invention, the polymer P is prepared using the monomer A. Preferably, the monomer A is chosen among acrylic acid, an acrylic acid salt and combinations thereof. The preferred monomer A is acrylic acid. Also preferably, the monomer A can be combined with at least one other monomer chosen among vinyl acetate, ethyl acrylate, methyl acrylate, hydroxyethylmethacrylate, hydroxyethylacrylate, hydroxypropylmethacrylate, hydroxypropylacrylate, 2-acrylamido-2-methylpropane sulphonic acid (AMPS), maleic acid, maleic anhydride, itaconic acid, their salts and combinations thereof. More advantageously, the monomer A is chosen among acrylic acid, an acrylic acid salt and combinations thereof, combined with at least one other monomer chosen among 2-acrylamido-2-methylpropane sulphonic acid, maleic acid, maleic anhydride, itaconic acid, their salts and combinations thereof.

Essentially according to the invention, the polymer P is prepared in the presence of at least one compound T comprising sulphur IV, sulphur in oxidation state IV (sulphur IV, S^{IV} or S IV). Preferably, the sulphur compound T is chosen among lithium hydrogen sulphite, sodium hydrogen sulphite, potassium hydrogen sulphite, ammonium hydrogen sulphite, calcium di(hydrogen sulphite), magnesium di(hydrogen sulphite) and combinations thereof. Preferentially according to the invention, the compound T is a mono-hydrogen sulphite. Sodium hydrogen sulphite or sodium bisulphite is more particularly preferred. Preferably according to the invention, the compound Tis a mineral derivative. Preferably according to the invention, the polymerisation reaction is carried out at a temperature above 30° C. and below 100° C., preferably below 90° C., more preferentially below 80° C. or below 75° C.

According to the invention, the polymer P is prepared in the presence of at least one initiator compound. Preferably, the initiator compound is chosen among a peroxide (for example hydrogen peroxide, tert-butyl hydroperoxide), a persulphate (for example sodium persulphate, ammonium persulphate, potassium persulphate), combinations thereof and associations thereof with a metal salt, preferably a metal salt chosen among an iron salt (for example Fe II or Fe III), a copper salt (for example Cu I or Cu II) and combinations thereof.

Advantageously, the polymer P can be partially non-neutralised, preferably non-neutralised by 2 mol % to 65 mol %, more preferentially non-neutralised by 25 mol % to 60 mol %, relative to the number of carboxyl groups. Essentially according to the invention, the polymer P is partially or completely neutralised by means of at least one monovalent ion. According to the invention, the carboxyl groups of the polymer P can be partially neutralised at a rate of 35 mol % to 98 mol %, preferably at a rate of 40 mol % to 75 mol %. Preferably, the polymer P is partially neutralised. Preferably according to the invention, the monovalent ion is chosen among K⁺, Na⁺, Li⁺, NH₄⁺ and combinations thereof. The particularly preferred ion is Nat. According to the invention, the polymer P can be neutralised by means of at least one compound chosen among NaOH, KOH, LiOH, ammonium derivatives and combinations thereof.

Preferably, the polymer P has a weight-average molecular mass Mw, measured by SEC, of less than 20,000 g/mol, preferably less than 15,000 g/mol, less than 10,000 g/mol, more preferentially less than 9,500 g/mol or less than 8,000 g/mol. The polymer P generally has a weight-average molecular mass Mw, measured by SEC, greater than 4,500 g/mol or greater than 5,000 g/mol, preferably greater than 5,500 g/mol or greater than 6,000 g/mol. According to the invention, the weight-average molecular mass Mw of the polymer P therefore advantageously ranges from 4,500 g/mol to 15,000 g/mol, from 4,500 g/mol to 10,000 g/mol, from 4,500 g/mol to 9,500 g/mol or from 4,500 g/mol to 8,000 g/mol. Also advantageously according to the invention, the weight-average molecular mass Mw of the polymer P ranges from 5,000 g/mol to 15,000 g/mol, from 5,000 g/mol to 10,000 g/mol, from 5,000 g/mol to 9,500 g/mol or from 5,000 g/mol to 8,000 g/mol. More advantageously according to the invention, the weight-average molecular mass Mw of the polymer P ranges from 5,500 g/mol to 15,000 g/mol, from 5,500 g/mol to 10,000 g/mol, from 5,500 g/mol to 9,500 g/mol or from 5,500 g/mol to 8,000 g/mol.

Preferably, the polymer P has a polymolecularity index PI, measured by SEC, of less than 4 or ranging from 1.9 to 4; from 1.9 to 3 or from 1.5 to 3; from 1.2 to 2.5 or from 1.9 to 2.9.

According to the invention, the molecular weight or mass of the polymer P is determined by Size Exclusion Chromatography (SEC). A test portion of the polymer dispersion corresponding to 90 mg of dry solids content is placed in a 10 mL flask. Mobile phase is added, together with 0.04% dimethylformamide (DMF), until a total mass of 10 g is reached. The composition of this mobile phase is as follows: NaHCO₃: 0.05 mol/L, NaNO₃: 0.1 mol/L, triethanolamine: 0.02 mol/L, NaN₃ 0.03% by mass. The SEC chain is composed of a “Waters” 510 isocratic pump with a flow rate set to 0.8 mL/min, of a “Waters” 717+ sample changer, of an oven containing a “Waters Ultrahydrogel Column Guard” precolumn 6 cm long and 40 mm in inner diameter, followed by a “Waters Ultrahydrogel” linear column 30 cm long and 7.8 mm in inner diameter. Detection is provided by means of a “Waters” 410 RI differential refractometer. The oven is brought to a temperature of 60° C. and the refractometer is brought to a temperature of 45° C. The SEC instrument is calibrated with a series of polyacrylate sodium standards supplied by “Polymer Standard Service” with a molecular weight at the top of the peak comprised between 900 and 2,250,000 g/mol and a polymolecularity index comprised between 1.4 and 1.7. The calibration curve is straight-line and takes into account the correction obtained using the flow rate marker: dimethylformamide (DMF). Acquisition and processing of the chromatogram are performed using the “WinGPC Scientific v 4.02” PSS software. The chromatogram obtained is incorporated into the area corresponding to molecular weights of more than 250 g/mol.

Preferably according to the invention, the molar amount of sulphur compound T present within the suspension S, preferably the molar amount of sulphur IV, is comprised between 1% and 15%, preferably between 1.5% and 12%, relative to the total molar amount of monomers used. More preferably according to the invention, the molar amount of sulphur compound T present within the suspension S, preferably the molar amount of sulphur IV, is comprised between 1% and 15%, preferably between 1.5% and 12%, relative to the total molar amount of unsaturated groups, preferably unsaturated ethylenic groups, in the monomers used.

When preparing the suspension S, the agent R according to the invention can be used in various ways.

Preferably according to the invention, the rheological agent R is introduced after grinding. It can also be introduced while concentrating the suspension Sd. It can also be introduced sequentially, with one fraction being introduced after grinding and before concentrating the suspensions Sd, another fraction being introduced while concentrating the suspension

### Sd.

According to the invention, the agent R can be introduced directly in the form of a combination of phosphoric acid and of the polymer P. According to the invention, the agent R can also be used by separately introducing the phosphoric acid and the polymer P, for example by introducing one first and then the other. The phosphoric acid and the polymer P can also be introduced separately and in sequence. Thus, the separate introduction of the phosphoric acid and of the polymer P can be carried out after grinding for one and while concentrating for the other. The phosphoric acid can be introduced after grinding and before concentrating and the polymer P can be introduced while concentrating; the introduction of the phosphoric acid can be continued while concentrating. The polymer P can also be introduced after grinding and before concentrating and the phosphoric acid can be introduced while concentrating; the introduction of the polymer P can be continued while concentrating.

Also preferably according to the invention, the rheological agent R is used in an amount by dry weight ranging from 0.05% by weight to 5% by weight relative to the amount by dry weight of mineral material M.

Within the agent R according to the invention, the amounts of phosphoric acid and of polymer P can vary. Preferably, the rheological agent R comprises:
from 5% by weight to 95% by weight of phosphoric acid and
from 5% by weight to 95% by weight of polymer P,
relative to the total amount by dry weight of agent R.

More preferably, the rheological agent R comprises:
from 15% by weight to 45% by weight of phosphoric acid and
from 55% by weight to 85% by weight of polymer P,
relative to the total amount by dry weight of agent R.

Advantageously according to the invention, the rheological agent R can also comprise a compound B chosen among a sulpho-carboxylic acid, a sulpho-carboxylic acid salt and combinations thereof, preferably present in a molar amount of less than 25% relative to the molar amount of sulphur IV, preferably a compound B chosen among sulpho-arylcarboxylic acids and sulpho-alkylcarboxylic acids. More preferentially, the compound B is chosen among 3-sulphopropionic acid, 3-sulpho-2-methylpropionic acid, sulpho-succinic acid, their salts and combinations thereof. The salts of the compound B are generally sodium salt, potassium salt, lithium salt, calcium salt, magnesium salt or ammonium salt.

Also preferentially according to the invention, the molar amount of compound B is less than 20%, preferably less than 15% or less than 12%, relative to the molar amount of sulphur IV, or the molar amount of compound B present within the suspension Sd is greater than 0.2%, in particular greater than 2% or greater than 5%, relative to the molar amount of sulphur IV.

In particular, the molar amount of compound B is greater than 2% or greater than 5% relative to the molar amount of sulphur IV. According to the invention, the molar amount of compound B present within the suspension S, relative to the molar amount of sulphur IV, is therefore generally comprised within the ranges of from 0.2% to 25%, from 2% to 25%, from 5% to 25%, from 0.2% to 20%, from 2% to 20%, from 5% to 20%, from 0.2% to 15%, from 2% to 15%, from 5% to 15%, from 0.2% to 12%, from 2% to 12%, from 5% to 12%.

According to the invention, the polymer P is prepared in the absence of any phosphorus compound. In particular, the polymer P is prepared in the absence of any compound comprising phosphorus in oxidation state I, in particular in the absence of hypophosphorous acid, sodium hypophosphite, potassium hypophosphite, lithium hypophosphite, ammonium hypophosphite, calcium hypophosphite and magnesium hypophosphite; or in the absence of any compound comprising phosphorus in oxidation state III, in particular in the absence of phosphorous acid and of phosphorous acid salt. The suspension S according to the invention is prepared by grinding the suspension Sd and by concentrating the suspension resulting from the grinding. Preferably according to the invention, the concentration step is carried out by thermal concentration, generally by heating. The heating temperature is generally above 80° C. Preferably, the heating temperature is generally below 110° C.

According to the invention, the concentration step can also be carried out by mechanical concentration, in particular by means of a device chosen among a settling tank, a centrifuge, a cyclone, a rotary filter and combinations thereof. According to the invention, the concentration step can also be carried out using a combination of thermal concentration and mechanical concentration.

Essentially according to the invention, the suspension S is prepared by grinding the suspension Sd of at least one particulate mineral material M in water. According to the invention, grinding can be carried out in the absence of any grinding aid agent or in the presence of at least one grinding aid agent.

Preferably according to the invention, grinding is carried out in water in the absence of any grinding aid agent and at a concentration ranging from 10% by weight to 40% by weight, preferably from 10% by weight to 30% by weight, of the aqueous suspension Sd.

Also preferably according to the invention, grinding is carried out in water in the presence of an aqueous grinding aid dispersion D comprising at least one polymer Q and at a concentration ranging from 30% by weight to 60% by weight, preferably from 40% by weight to 60% by weight, of the aqueous suspension Sd. According to the invention, the suspension S thus results from grinding in water in the presence of an aqueous grinding aid dispersion D comprising at least one polymer Q with a molecular mass by weight (M_{W}), measured by SEC, comprised between 4,000 g/mol and 20,000 g/mol and prepared in water or in an organic solvent, optionally in the absence of any phosphorus compound, by a polymerisation reaction of at least one monomer G chosen among acrylic acid, methacrylic acid, an acrylic acid salt, a methacrylic acid salt and combinations thereof, in the presence of at least one initiator compound and of at least one chain transfer compound H during the polymerisation reaction, and completely or partially neutralised by means of at least one ion chosen among a monovalent ion, a divalent ion and combinations thereof.

Preferably according to the invention, during grinding, the amount of aqueous dispersion D used ranges from 0.05% by weight to 5% by weight, preferably from 0.2% by weight to 1.5% by weight or from 0.2% by weight to 1% by weight, relative to the amount of mineral material M.

Advantageously according to the invention, the polymer Q can be partially or completely neutralised by means of a combination of at least one monovalent ion and of at least one divalent ion. According to the invention, the carboxyl groups of the polymer Q can be partially neutralised at a rate of 50 mol % to 97 mol %, preferably at a rate of 65 mol % to 90 mol %. Preferably, the polymer P is partially neutralised.

According to the invention, the polymer Q can be completely or partially neutralised in variable relative molar proportions of monovalent and divalent ions. Preferably according to the invention, the monovalent ion/divalent ion molar proportions are comprised between 90/10 and 10/90 or between 80/20 and 20/80, preferably between 80/20 and 60/40, for example 70/30 or 50/50.

Preferably according to the invention, the monovalent ion is chosen among K⁺, Na⁺, Li⁺, NH₄⁺ and combinations thereof. The particularly preferred monovalent ion is Nat. According to the invention, the polymer Q can be neutralised by means of at least one compound chosen among NaOH, KOH, LiOH, ammonium derivatives and combinations thereof. Also preferably according to the invention, the divalent ion is chosen among Ca²⁺, Mg²⁺ and combinations thereof. The particularly preferred ion is Ca²⁺. According to the invention, the polymer Q can be neutralised by means of at least one compound chosen among CaO, Ca(OH)₂, MgO, Mg(OH)₂ and combinations thereof. Preferably, the polymer Q can be completely or partially neutralised by means of a combination of Na⁺ and of Ca²⁺ or of a combination of Na⁺, of Ca²⁺ and of Mg²⁺.

Preferably according to the invention, the aqueous grinding aid dispersion D comprises at least one polymer Q chosen among:
an α-sulphonated polymer Q1 with a molecular mass by weight (M_{W}), measured by SEC, comprised between 4,000 g/mol and 20,000 g/mol and prepared in water, optionally in the absence of any phosphorus compound, by a polymerisation reaction of at least one monomer G chosen among acrylic acid, methacrylic acid, an acrylic acid salt, a methacrylic acid salt and combinations thereof, in the presence of at least one initiator compound and of at least one sulphur compound H1 comprising sulphur in oxidation state IV (sulphur IV or S^{IV}), and completely or partially neutralised by means of at least one ion chosen among a monovalent ion, a divalent ion and combinations thereof,
a polymer Q2 with a molecular mass by weight (M_{W}), measured by SEC, comprised between 4,000 g/mol and 20,000 g/mol and prepared in water or in an organic solvent, optionally in the absence of any phosphorus compound, by a polymerisation reaction of at least one monomer G chosen among acrylic acid, methacrylic acid, an acrylic acid salt, a methacrylic acid salt and combinations thereof, in the presence of at least one initiator compound and of a compound H2 chosen among the secondary alcohols, and completely or partially neutralised by means of at least one ion chosen among a monovalent ion, a divalent ion and combinations thereof,
a polymer Q3 with a molecular mass by weight (M_{W}), measured by SEC, comprised between 4,000 g/mol and 20,000 g/mol and prepared in water, by a polymerisation reaction of at least one monomer G chosen among acrylic acid, methacrylic acid, an acrylic acid salt, a methacrylic acid salt and combinations thereof, in the presence of at least one initiator compound and of at least one compound H3 comprising phosphorus and chosen among a compound comprising phosphorus in oxidation state I, a compound comprising phosphorus in oxidation state III and combinations thereof, and completely or partially neutralised by means of at least one ion chosen among a monovalent ion, a divalent ion and combinations thereof and
a polymer Q4 with a molecular mass by weight (M_{W}), measured by SEC, comprised between 4,000 g/mol and 20,000 g/mol and prepared in water, by a polymerisation reaction of at least one monomer G chosen among acrylic acid, methacrylic acid, an acrylic acid salt, a methacrylic acid salt and combinations thereof, in the presence of at least one initiator compound and of at least one compound H4 of formula II:

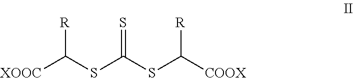

wherein X represents Na, K or H and R represents a C₁-C₅ alkyl group, preferably a methyl group;
and completely or partially neutralised by means of at least one ion chosen among a monovalent ion, a divalent ion and combinations thereof.

According to the invention, the chain transfer compound H is used during the polymerisation reaction to obtain the polymer Q. Preferably according to the invention, the compound H is chosen among a compound H1, a compound H2, a compound H3 and a compound H4.

Preferably, the compound H1 is chosen among lithium hydrogen sulphite, sodium hydrogen sulphite, potassium hydrogen sulphite, ammonium hydrogen sulphite, calcium di(hydrogen sulphite), magnesium di(hydrogen sulphite) and combinations thereof. Preferentially according to the invention, the compound H1 is a mono-hydrogen sulphite. Sodium hydrogen sulphite or sodium bisulphite is more particularly preferred.

Preferably, the compound H2 is isopropyl alcohol.

Preferably, the compound H3 is chosen among hypophosphorous acid, sodium hypophosphite, potassium hypophosphite, lithium hypophosphite, ammonium hypophosphite, calcium hypophosphite, magnesium hypophosphite, phosphorous acid, a phosphorous acid salt and combinations thereof. Preferentially according to the invention, the compound H3 is sodium hypophosphite.

Preferably, the compound H4 is dipropyl trithiocarbonate (CAS No. 6332-91-8) or one of its salts, for example its disodium salt, sodium dipropionate trithiocarbonate (CAS No. 86470-33-2).

According to the invention, the polymer Q is prepared using the monomer G. Preferably, the monomer G is chosen among acrylic acid, methacrylic acid, an acrylic acid salt, a methacrylic acid salt and combinations thereof. Advantageously, the monomer G can be combined with at least one other monomer chosen among vinyl acetate, methyl acrylate, ethyl acrylate, hydroxyethylmethacrylate, hydroxyethylacrylate, hydroxypropylmethacrylate, hydroxypropylacrylate, 2-acrylamido-2-methylpropane sulphonic acid (AMPS), maleic acid, maleic anhydride, itaconic acid and combinations thereof. More advantageously, the monomer G is chosen among acrylic acid, methacrylic acid, an acrylic acid salt, a methacrylic acid salt and combinations thereof, combined with at least one other monomer chosen among vinyl acetate, methyl acrylate, ethyl acrylate, hydroxyethylmethacrylate, hydroxyethylacrylate, hydroxypropylmethacrylate, hydroxypropylacrylate, 2-acrylamido-2-methylpropane sulphonic acid (AMPS), maleic acid, maleic anhydride, itaconic acid and combinations thereof.

Preferably, the polymer Q has a weight-average molecular mass Mw (measured by SEC) of less than 20,000 g/mol, preferably less than 15,000 g/mol, less than 10,000 g/mol, more preferentially less than 7,000 g/mol or less than 6,000 g/mol. The polymer Q generally has a weight-average molecular mass Mw (measured by SEC) greater than 4,500 g/mol or greater than 5,000 g/mol. Preferably, the polymer Q has a polymolecularity index PI (measured by SEC) of less than 4 or ranging from 1.2 to 4 or from 1.5 to 4; from 1.2 to 3.5 or from 1.5 to 3.5; from 1.2 to 3 or even from 1.5 to 3.

According to the invention, the temperature and initiator compound used during the polymerisation reaction to prepare the polymer Q are similar to the temperature and initiator compound for preparing the polymer P.

The invention also relates to the preparation of the suspension S according to the invention. Thus, the invention provides a method of preparing a suspension S comprising:
grinding in water an aqueous suspension Sd of at least one particulate mineral material M at a concentration ranging from 10% by weight to 60% by weight, then
concentrating the ground suspension Sd to a concentration ranging from 65% by weight to 80% by weight, by a treatment chosen among mechanical treatment, heat treatment and combinations thereof, in the presence of at least one rheological agent R comprising phosphoric acid and at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised by means of at least one monovalent ion.

Essentially, the preparation of the suspension S according to the invention uses the rheological agent R. The invention also relates to this agent. The invention thus provides a rheological agent R comprising phosphoric acid and at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised by means of at least one monovalent ion, and optionally a compound B chosen among a sulpho-carboxylic acid, a sulpho-carboxylic acid salt and combinations thereof, preferably present in a molar amount of less than 25% relative to the molar amount of sulphur IV.

The rheological agent R according to the invention is particularly effective when used within an aqueous suspension S of particles according to the invention. The invention therefore also provides a method of controlling the rheology of an aqueous suspension S of particles of at least one mineral material M prepared:
by grinding in water an aqueous suspension Sd of at least one particulate mineral material M at a concentration ranging from 10% by weight to 60% by weight, then
by concentrating the ground suspension Sd to a concentration ranging from 65% by weight to 80% by weight, by a treatment chosen among mechanical treatment, heat treatment and combinations thereof, comprising the use during concentration of at least one rheological agent R comprising phosphoric acid and at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised by means of at least one monovalent ion.

The aqueous suspension S obtained using the invention has particularly advantageous properties and can be used in many technical fields, in particular for paper preparation. The invention thus provides a method of preparing a mass filler composition for papermaking or a paper coating colour composition comprising:
preparing an aqueous suspension S according to the invention comprising:
   grinding in water an aqueous suspension Sd of at least one particulate mineral material M at a concentration ranging from 10% by weight to 60% by weight, then
   concentrating the ground suspension Sd to a concentration ranging from 65% by weight to 80% by weight, by a treatment chosen among mechanical treatment, heat treatment and combinations thereof, in the presence of at least one rheological agent R comprising phosphoric acid and at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised by means of at least one monovalent ion, then
mixing the aqueous suspension S with at least one binding compound, and optionally with at least one compound chosen among a rheology modifying compound, a water retention agent, an optical brightening agent, an organic pigment, a mineral pigment and combinations thereof.

This method of preparing paper comprises the use of a suspension S according to the invention, in particular when applying a paper coating colour or when adding a filler composition.

The aqueous suspension S obtained using the invention can also be used to prepare a coating composition, in particular a varnish or a paint. Thus, the invention provides a method of preparing a coating composition comprising:
preparing an aqueous suspension S according to the invention comprising:
   grinding in water an aqueous suspension Sd of at least one particulate mineral material M at a concentration ranging from 10% by weight to 60% by weight, then
   concentrating the ground suspension Sd to a concentration ranging from 65% by weight to 80% by weight, by a treatment chosen among mechanical treatment, heat treatment and combinations thereof, in the presence of at least one rheological agent R comprising phosphoric acid and at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised by means of at least one monovalent ion, then
mixing the aqueous suspension S with at least one binding compound, and optionally with at least one compound chosen among a rheology modifying compound, an organic pigment, a mineral pigment and combinations thereof.

The coating composition according to the invention comprises:
at least one aqueous suspension S according to the invention prepared:
   by grinding in water an aqueous suspension Sd of at least one particulate mineral material M at a concentration ranging from 10% by weight to 60% by weight, then
   by concentrating the ground suspension Sd to a concentration ranging from 65% by weight to 80% by weight, by a treatment chosen among mechanical treatment, heat treatment and combinations thereof, in the presence of at least one rheological agent R comprising phosphoric acid and at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt and combinations thereof, in the presence of at least one initiator compound and of at least one sulphur compound T comprising sulphur in oxidation state IV, and completely or partially neutralised by means of at least one monovalent ion, and
at least one binding compound, and optionally at least one compound chosen among a rheology modifying compound, a mineral pigment, an organic pigment and combinations thereof.

The invention also provides a method of preparing a coating comprising applying a coating composition according to the invention to a substrate.

According to the invention, the particular, advantageous or preferred characteristics of the suspension S according to the invention define methods for its preparation, methods which use it as well as rheological agents R which are also particular, advantageous or preferred.

The following examples illustrate the various aspects of the invention.

### EXAMPLES

### Preparation and Characterisation of a Dispersion of the Polymer Pla According to the Invention

In a 1 litre glass reactor equipped with a stirrer, a thermometer, a glass cooling unit and a heating system, a load comprising 0.003 g of iron sulphate heptahydrate and 226.7 g of water is prepared at room temperature. Then, 3 loads to be introduced separately and in parallel over 3 hours are prepared. In a first beaker 254 g of acrylic acid (monomer A) are introduced, in a second beaker 1.54 g of sodium persulphate and 40.8 g of water are introduced and in a third beaker 36.84 g of a 40% by mass aqueous sodium bisulphite solution (compound T) are introduced. After 3 hours of addition at 73° C., a clear dispersion of polymer is obtained. The dry solids concentration of the polymer dispersion is 50.9%. The polymer Pla obtained has an Mw of 6,485 g/mol and a PI of 2.5.

The compound B and the amount of compound B (mol % relative to the molar amount of sulphur IV of the compound T used) contained in the polymer dispersion Pla are determined by assaying the sulphate ions using ion chromatography, the 3-sulphopropionic ions, by ¹H NMR and ¹³C NMR analysis of the sulphonated groups of the polymer Pla and of the compound B.

The sulphate ion level in the polymer dispersion Pla is determined by ion chromatography. A test portion of about 80 mg of the polymer dispersion is introduced into a 15 mL vial. Mobile phase is added to a total mass of 15 g. The composition of the mobile phase is as follows: sodium carbonate: 0.009 mol/L. The ion chromatography chain for the anion assay consists of a “Dionex Aquion” ion chromatography system with built-in degasser, of which the flow rate is set at 1 mL/min, containing a chemical suppressor, an AG9-HC precolumn, a CG3 metal trap precolumn, an NG1 precolumn and an AG9-HC column. A conductimetric detector is used for detection. The ion chromatography instrument is calibrated with a series of sodium sulphate solution standards. The calibration range is comprised between 0.5 and 100 ppm. The calibration curve is straight-line. The instrument automatically dilutes the samples to ensure that they are within the calibration range. Acquisition and processing of the chromatogram are performed using “Chromeleon” software 7.2.10.

¹H NMR and ¹³C NMR analyses are carried out using a “Bruker” AV III HD 500 spectrometer equipped with a 5 mm BBI probe. The polymer samples were dissolved in deuterated water and examined by ¹H NMR and ¹³C NMR using 2D experiments: correlations ¹H/¹³C at ordinary distance and at long distance.

The dispersion of polymer Pla according to the invention comprises 3-sulphopropionic acid as compound B in an amount of 15 mol % relative to the molar amount of sodium bisulphite used (compound T).

### Preparation and Characterisation of an Aqueous Dispersion D2 of the Polymer Q2a According to the Invention

In a 1 litre glass reactor equipped with a stirrer, a thermometer, a glass cooling unit and a heating system, a load comprising 0.19 g of iron sulphate heptahydrate, 0.58 g of hydroxylamine sulphate, 121 g of isopropyl alcohol (compound H2) and 110 g of water is prepared at room temperature. Then, 3 loads to be introduced separately and in parallel over 2 hours are prepared. In a first beaker 276.52 g of acrylic acid (monomer A) are introduced, in a second beaker 3.6 g of 130 volume dihydrogen peroxide and 100 g of water are introduced and in a third beaker 0.63 g of hydroxylamine sulphate and 100 g of water are introduced.

After 2 hours of addition at reflux, the isopropyl alcohol (compound H2) is separated by distillation and the polymer is diluted with water. After flushing the injection systems, the product of the polymerisation reaction is neutralised. For this, two loads are prepared and introduced successively. In a first beaker 21.96 g of hydrated lime and 82.5 g of water are introduced, in a second beaker 17.06 g of magnesium hydroxide and 31.10 g of water are introduced. After flushing the injection systems, 138.26 g of 50% sodium hydroxide are added to the reactor. The mixture is left to react at a temperature comprised between 80° C. and 85° C. for 45 minutes. A clear aqueous dispersion D2 is obtained comprising at least one polymer Q2a whose carboxyl groups are partially neutralised to a rate of 45 mol % with sodium ion, 15 mol % with calcium ion and 15 mol % with magnesium ion.

The concentration of dry solids content in the aqueous dispersion D2 is 37%. The polymer Q2a obtained has an Mw of 9,760 g/mol and a PI of 3.

### Preparation and Characterisation of a Rheological Agent R1 According to the Invention

85.5 g of an aqueous sodium hydroxide solution (50% by weight), 109.5 g of an 85% by weight aqueous phosphoric acid solution and 344.7 g of the polymer dispersion Pla obtained previously and 109.8 g of water are mixed under stirring while maintaining the temperature at room temperature. This results in the rheological agent R1 according to the invention

### (SC=46.4%).

### Preparation and Characterisation of a Suspension S1 According to the Invention

1,425 g of calcium carbonate (“Omya” BL 200) are dispersed in 4,275 g of water under mechanical stirring using a “Rayneri” motor. Stirring is continued for 20 minutes. Then, grinding is carried out using a grinder (“Wab Dyno Mill” type KDL pilot 1.4 L) containing 2,850 g of ceramic beads (ER 120 S from 0.6 mm to 1.0 mm in diameter—“Saint Gobain”). The grinding conditions are adjusted so as to obtain a suspension of particles of mineral material with the desired particle size distribution. The concentration of the suspension Sd1 to be ground is 25%±1%. Grinding is continued to achieve the desired particle size distribution (75%±1% by weight of particles with an equivalent spherical diameter <1 μm). The particle size characteristics are determined using a “SediGraph” III 5120 sedimentation meter (“Micromeritics”, USA).

The particle size distribution of the suspensions of particles of mineral material is measured. This enables the mass fraction to be determined as a percentage of a population of particles with an equivalent spherical diameter of less than 1 μm (esd<1 μm, expressed in %). These measurements are carried out for an aqueous suspension of particles of mineral material diluted to a concentration of approximately 37 g of dry solids content per litre of solution and comprising 4,000 g/mol by Mw of standard sodium polyacrylate at a concentration of 2.25 dry g/L. Each sample is dispersed and sonicated prior to particle size measurement.

This suspension Sd1 is then thermally concentrated to a concentration of 71%±1% by evaporating water using a “Vorwerk” instrument in the presence of 0.8% by dry weight relative to the dry weight of dry calcium carbonate of rheological agent R1 according to the invention added in 3 equal portions during the thermal concentration.

The resulting suspension S1 is then characterised by checking its pH at 25° C. and its solids content (SC, % by weight) using a “Précisa” scale. Its Brookfield viscosity at 100 rpm denoted BVO (in mPa·s) is measured at 25° C. using a “Brookfield” DV3T rheometer equipped with a module 3. A stability study is carried out after the suspension SI has been stored for 24 hours in a climate-controlled chamber at 60° C. The Brookfield viscosity of this suspension SI denoted BV24 (in mPa·s) is measured at 25° C. and before stirring at 100 rpm using a “Brookfield” DV3T rheometer equipped with a module 5. The suspension S1 is stirred using a “Rayneri” mechanical motor for 1 minute at 2,000 rpm before measuring its Brookfield viscosity denoted BV24a (in mPa·s) at 25° C. at 100 rpm using the Brookfield rheometer equipped with a module 3. The results obtained are shown in Table 1.

TABLE 1

| Polymer P | esd (%) | BV0 | BV24 | BV24a | pH | SC |
|---|---|---|---|---|---|---|
| P1a | 75.2 | 168 | 234 | 170 | 10 | 71.7 |

The use of a polymer Pla according to the invention makes it possible to prepare a highly concentrated mineral suspension and to effectively control its viscosity and its stability.

### Preparation and Characterisation of a Suspension S2 According to the Invention

Under mechanical stirring using a “Rayneri” motor, 4,000 g of calcium carbonate (“Omyacarb” 10 AV “Omya”) are dispersed in 4,000 g of water in the presence of 0.45% by dry weight relative to the dry weight of dry calcium carbonate of aqueous dispersion D2. Stirring is continued for 20 minutes.

Then, grinding is carried out using a grinder (“Wab Dyno Mill” type KDL pilot 1.4 L) containing 2,800 g of ceramic beads (ER 120 S from 0.6 mm to 1.0 mm in diameter-“Saint Gobain”). The grinding conditions are adjusted so as to obtain a suspension of particles of mineral material with the desired particle size distribution. The concentration of the suspension Sd2 to be ground is 50%±1%. Grinding is continued to achieve the desired particle size distribution (75%±1% by weight of particles with an equivalent spherical diameter <1 μm). The particle size distribution characteristics are determined using a “SediGraph” III 5120 sedimentation meter (“Micromeritics”, USA).

The particle size distribution of the suspensions of particles of mineral material is measured. This enables the mass fraction to be determined as a percentage of a population of particles with an equivalent spherical diameter of less than 1 μm (esd<1 μm, expressed in %). These measurements are carried out for an aqueous suspension of particles of mineral material diluted to a concentration of approximately 37 g of dry solids content per litre of solution and comprising 4,000 g/mol by Mw of standard sodium polyacrylate at a concentration of 2.25 dry g/L. Each sample is dispersed and sonicated prior to particle size measurement.

This suspension Sd2 is then thermally concentrated to a concentration of 71%±1% by evaporating water using a “Vorwerk” instrument in the presence of 0.25% by dry weight relative to the dry weight of dry calcium carbonate of rheological agent R1 according to the invention.

The resulting suspension S2 is then characterised by checking its pH at 25° C. and its solids content (SC, % by weight) using a “Précisa” scale. Its Brookfield viscosity at 100 rpm denoted BVO (in mPa·s) is measured at 25° C. using a “Brookfield” DV3T rheometer equipped with a module 3. A stability study is carried out after the suspension S2 has been stored for 24 hours in a climate-controlled chamber at 60° C. The Brookfield viscosity of this suspension S2 denoted BV24 (in mPa·s) is measured at 25° C. and before stirring at 100 rpm using a “Brookfield” DV3T rheometer equipped with a module 5. The suspension S2 is stirred using a “Rayneri” mechanical motor for 1 minute at 2,000 rpm before measuring its Brookfield viscosity denoted BV24a (in mPa·s) at 25° C. at 100 rpm using the Brookfield DV3T rheometer equipped with a module 3. The results obtained are shown in Table 2.

TABLE 2

| Polymer P | esd (%) | BV0 | BV24 | BV24a | pH | SC |
|---|---|---|---|---|---|---|
| P1a | 75.5 | 557 | 1,860 | 520 | 8.8 | 71.2 |

The use of a polymer Pla after grinding in the presence of an aqueous dispersion D2 of the polymer Q2a according to the invention makes it possible to prepare a highly concentrated mineral suspension and to effectively control its viscosity and its stability.

1. An aqueous suspension S of particles comprising at least one mineral material M prepared by a method comprising, in order:
grinding in water an aqueous suspension Sd of at least one particulate mineral material M at a concentration ranging from 10% by weight to 60% by weight; and
concentrating the ground suspension Sd to a concentration ranging from 65% by weight to 80% by weight, by a treatment chosen among mechanical treatment, heat treatment, and combinations thereof, in the presence of at least one rheological agent R comprising phosphoric acid and at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt, and combinations thereof, in the presence of at least one initiator compound and of at least one sulphur compound T comprising sulphur in oxidation state IV, and completely or partially neutralised by at least one monovalent ion.

2. The suspension S according to claim 1, wherein:
the Brookfield viscosity at 25° C., at 100 rpm, measured 1 hour after its preparation, is less than 1,000 mPa·s, or
the Brookfield viscosity at 25° C., at 100 rpm and after stirring, measured 24 hours after preparation and storage at 60° C., is less than 800 mPa·s, or
the Brookfield viscosity at 25° C., at 100 rpm and before stirring, measured 24 hours after preparation and storage at 60° C., is less than 3,000 mPa·s.

3. The suspension S according to claim 1 wherein:
the particles comprise a single material M or two or three materials M or
the material M is synthetic or of natural origin, or
the concentration of the suspension S is greater than 70% by weight or is less than 78% by weight.

4. The suspension S according to claim 1, wherein:
the particles of ground material M have a median size, measured by sedimentation analysis, of less than 50 μm or a median size ranging from 0.05 to 50 μm or a median size of less than 10 μm, or
the concentration of the suspension Sd is greater than 10% by weight or the concentration of the suspension Sd is less than 60% by weight.

5. The suspension S according to claim 1, wherein the polymer P is chosen among an α-ω-disulphonated polymer P1, an α-monosulphonated polymer P2, and combinations thereof.

6. The suspension S according to claim 1, wherein:
the monomer A is chosen among acrylic acid, an acrylic acid salt, and combinations thereof, or
the monomer A is combined with at least one other monomer chosen among vinyl acetate, ethyl acrylate, methyl acrylate, hydroxyethylmethacrylate, hydroxyethylacrylate, hydroxypropylmethacrylate, hydroxypropylacrylate, 2-acrylamido-2-methylpropane sulphonic acid (AMPS), maleic acid, maleic anhydride, itaconic acid, their salts, and combinations thereof, or
the monomer A is chosen among acrylic acid, an acrylic acid salt, and combinations thereof, combined with at least one other monomer chosen among 2-acrylamido-2-methylpropane sulphonic acid, maleic acid, maleic anhydride, itaconic acid, their salts, and combinations thereof, or
the sulphur compound T is chosen among lithium hydrogen sulphite, sodium hydrogen sulphite, potassium hydrogen sulphite, ammonium hydrogen sulphite, calcium di(hydrogen sulphite), magnesium di(hydrogen sulphite), and combinations thereof, or
the polymerisation reaction is carried out at a temperature above 30° C. and below 100° C., or
the polymer P is prepared in the presence of at least one initiator compound chosen among a peroxide, a persulphate, combinations thereof and associations thereof with a metal salt, or
the polymer P is partially non-neutralised or the polymer P is partially or completely neutralised, or
the polymer P is completely or partially neutralised by at least one monovalent ion chosen among K⁺, Na⁺, Li⁺, NH₄⁺, and combinations thereof, or
the polymer P has a weight-average molecular mass Mw, measured by SEC, of less than 20,000 g/mol, or
the polymer P has a weight-average molecular mass Mw, measured by SEC, greater than 4,500 g/mol, or
the polymer P has a polymolecularity index PI, measured by SEC, of less than 4.

7. The suspension S according to claim 1, wherein:
the molar amount of sulphur compound T is comprised between 1% and 15%, relative to the total molar amount of monomers used.

8. The suspension S according to claim 1, wherein:
the rheological agent R is introduced after grinding, or
the rheological agent R is used in an amount by dry weight ranging from 0.05% by weight to 5% by weight relative to the amount by dry weight of mineral material M, or
the rheological agent R comprises:
from 5% by weight to 95% by weight of phosphoric acid; and
from 5% by weight to 95% by weight of polymer P, relative to the total amount by dry weight of agent R, or
the rheological agent R further comprises a compound B chosen among a sulpho-carboxylic acid, a sulpho-carboxylic acid salt, and combinations thereof, or
the molar amount of compound B present within the suspension Sd is greater than 0.2%, relative to the molar amount of sulphur IV.

9. The suspension S according to claim 1, wherein the grinding is carried out in water in the absence of a grinding aid agent or is carried out in the presence of an aqueous grinding aid dispersion D comprising at least one polymer Q with a molecular mass by weight (M_{W}), measured by SEC, comprised between 4,000 g/mol and 20,000 g/mol and prepared in water or in an organic solvent, optionally in the absence of any phosphorus compound, by a polymerisation reaction of at least one monomer G chosen among acrylic acid, methacrylic acid, an acrylic acid salt, a methacrylic acid salt, and combinations thereof, in the presence of at least one initiator compound and of at least one chain transfer compound H during the polymerisation reaction, and completely or partially neutralised by at least one ion chosen among a monovalent ion, a divalent ion, and combinations thereof, preferably in the presence of an aqueous grinding aid dispersion D comprising at least one polymer Q chosen among:
an α-sulphonated polymer Q1 with a molecular mass by weight (M_{W}), measured by SEC, comprised between 4,000 g/mol and 20,000 g/mol and prepared in water, optionally in the absence of any phosphorus compound, by a polymerisation reaction of at least one monomer G chosen among acrylic acid, methacrylic acid, an acrylic acid salt, a methacrylic acid salt, and combinations thereof, in the presence of at least one initiator compound and of at least one sulphur compound H1 comprising sulphur in oxidation state IV, and completely or partially neutralised by at least one ion chosen among a monovalent ion, a divalent ion, and combinations thereof,
a polymer Q2 with a molecular mass by weight (M_{W}), measured by SEC, comprised between 4,000 g/mol and 20,000 g/mol and prepared in water or in an organic solvent, optionally in the absence of any phosphorus compound, by a polymerisation reaction of at least one monomer G chosen among acrylic acid, methacrylic acid, an acrylic acid salt, a methacrylic acid salt, and combinations thereof, in the presence of at least one initiator compound and of a compound H2 chosen among secondary alcohols, and completely or partially neutralised by at least one ion chosen among a monovalent ion, a divalent ion, and combinations thereof,
a polymer Q3 with a molecular mass by weight (M_{W}), measured by SEC, comprised between 4,000 g/mol and 20,000 g/mol and prepared in water, by a polymerisation reaction of at least one monomer G chosen among acrylic acid, methacrylic acid, an acrylic acid salt, a methacrylic acid salt, and combinations thereof, in the presence of at least one initiator compound and of at least one compound H3 comprising phosphorus and chosen among a compound comprising phosphorus in oxidation state I, a compound comprising phosphorus in oxidation state III, and combinations thereof, and completely or partially neutralised by at least one ion chosen among a monovalent ion, a divalent ion, and combinations thereof, and
a polymer Q4 with a molecular mass by weight (M_{W}), measured by SEC, comprised between 4,000 g/mol and 20,000 g/mol and prepared in water, by a polymerisation reaction of at least one monomer G chosen among acrylic acid, methacrylic acid, an acrylic acid salt, a methacrylic acid salt, and combinations thereof, in the presence of at least one initiator compound and of at least one compound H4 of formula II: 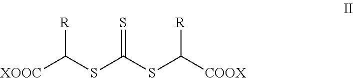
wherein X represents Na, K, or H; and R represents a C₁-C₅ alkyl group; and
completely or partially neutralised by at least one ion chosen among a monovalent ion, a divalent ion, and combinations thereof.

10. The suspension S according to claim 9, wherein:
the grinding is carried out in water in the absence of any grinding aid agent and at a concentration ranging from 10% by weight to 40% by weight of the aqueous suspension Sd or
the grinding is carried out in water in the presence of an aqueous grinding aid dispersion D comprising at least one polymer Q and at a concentration ranging from 30% by weight to 60% by weight of the aqueous suspension Sd.

11. A method for preparing the aqueous suspension S according to claim 1, the method comprising, in order:
grinding in water an aqueous suspension Sd of at least one particulate mineral material M at a concentration ranging from 10% by weight to 60% by weight; and
concentrating the ground suspension Sd to a concentration ranging from 65% by weight to 80% by weight, by a treatment chosen among mechanical treatment, heat treatment, and combinations thereof, in the presence of at least one rheological agent R comprising phosphoric acid and at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt, and combinations thereof, in the presence of at least one initiator compound and of at least one sulphur compound T comprising sulphur in oxidation state IV, and completely or partially neutralised by at least one monovalent ion.

12. A rheological agent R comprising phosphoric acid and at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt, and combinations thereof, in the presence of at least one initiator compound and of at least one sulphur compound T comprising sulphur in oxidation state IV, and completely or partially neutralised by at least one monovalent ion, and optionally a compound B chosen among a sulpho-carboxylic acid, a sulpho-carboxylic acid salt, and combinations thereof.

13. A method for preparing a mass filler composition for papermaking or a paper coating colour composition, the method comprising, in order:
preparing an aqueous suspension S according to claim 1, comprising, in order:
grinding in water an aqueous suspension Sd of at least one particulate mineral material M at a concentration ranging from 10% by weight to 60% by weight; and
concentrating the ground suspension Sd to a concentration ranging from 65% by weight to 80% by weight, by a treatment chosen among mechanical treatment, heat treatment, and combinations thereof, in the presence of at least one rheological agent R comprising phosphoric acid and at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt, and combinations thereof, in the presence of at least one initiator compound and of at least one sulphur compound T comprising sulphur in oxidation state IV, and completely or partially neutralised by at least one monovalent ion; and
mixing the aqueous suspension S with at least one binding compound, and optionally with at least one compound chosen among a rheology modifying compound, a water retention agent, an optical brightening agent, an organic pigment, a mineral pigment, and combinations thereof.

14. A method for preparing paper comprising contacting a suspension S according to claim 1 with a pulp.

15. A method for preparing a coating composition, the method comprising, in order:
preparing the aqueous suspension S according to claim 1 by a method comprising, in order:
grinding in water an aqueous suspension Sd of at least one particulate mineral material M at a concentration ranging from 10% by weight to 60% by weight;
concentrating the ground suspension Sd to a concentration ranging from 65% by weight to 80% by weight, by a treatment chosen among mechanical treatment, heat treatment, and combinations thereof, in the presence of at least one rheological agent R comprising phosphoric acid and at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt, and combinations thereof, in the presence of at least one initiator compound and of at least one sulphur compound T comprising sulphur in oxidation state IV, and completely or partially neutralised by at least one monovalent ion; and
mixing the aqueous suspension S with at least one binding compound, and optionally with at least one compound chosen among a rheology modifying compound, an organic pigment, a mineral pigment, and combinations thereof.

16. A coating composition, comprising:
at least one aqueous suspension S according to claim 1;
and
at least one binding compound.

17. A method for preparing a coating, the method comprising:
applying the coating composition according to claim 16 to a substrate.

18. A method for controlling the rheology of an aqueous suspension S of particles comprising at least one mineral material M prepared by a method comprising, in order:
grinding in water an aqueous suspension Sd of at least one particulate mineral material M at a concentration ranging from 10% by weight to 60% by weight; and
concentrating the ground suspension Sd to a concentration ranging from 65% by weight to 80% by weight, by a treatment chosen among mechanical treatment, heat treatment, and combinations thereof, comprising the use during concentration of at least one rheological agent R comprising phosphoric acid and at least one α-sulphonated polymer P prepared in water and in the absence of any phosphorus compound, by a polymerisation reaction of at least one monomer A chosen among acrylic acid, methacrylic acid, an acrylic acid salt, a methacrylic acid salt, and combinations thereof, in the presence of at least one initiator compound and of at least one sulphur compound T comprising sulphur in oxidation state IV, and completely or partially neutralised by at least one monovalent ion.
